(19) United States
(12) Patent Application Publication
(10) Pub. No.: US 2013/0219842 A1
(43) Pub. Date: Aug. 29, 2013

(54) VARIABLE LENGTH BAG CAGE

(71) Applicants: Greg Strugalski, Lee's Summit, MO (US); James Roy Doehla, Pleasant Hill, MO (US); Robert Warren Taylor, Ponte Vedra Beach, FL (US); Heath Curtis Johnson, Harrisonville, MO (US)

(72) Inventors: Greg Strugalski, Lee's Summit, MO (US); James Roy Doehla, Pleasant Hill, MO (US); Robert Warren Taylor, Ponte Vedra Beach, FL (US); Heath Curtis Johnson, Harrisonville, MO (US)

(73) Assignee: General Electric Company, Schenectady, NY (US)

(21) Appl. No.: 13/405,390

(22) Filed: Feb. 27, 2012

(51) Int. Cl. B01D 46/02

(52) U.S. Cl. 55/379

(57) ABSTRACT

A filter for use within a baghouse for filtering particulate material from fluid flow. The filter is to be supported by a tubesheet of the baghouse. The filter includes an elongate bag that has an open end adapted to be disposed adjacent to the tubesheet and an encircling sidewall that extends from the open end to a distal end of the bag. The sidewall permits passage of fluid there through so that the fluid may pass through the bag and blocks passage of particulate material. The filter includes an elongate cage that is located within and supporting the bag and that has a variable effective length. The filter includes cage-associated structure for increasing the effective length of the cage to maintain the sidewall to be taut adjacent the cage. The cage may include structure inhibiting movement of the cage. The filter may be part of a baghouse assembly.

### BACKGROUND OF THE INVENTION

1. Field of the Invention

The present invention relates generally to fluid (e.g., air) filters, and more particularly, to bag fluid filters that can be utilized in a baghouse.

2. Discussion of the Prior Art

Fluid filters are known and used in many different applications, including baghouses. Each baghouse may be provided with one or more fluid filters for filtering dirty fluid (e.g., air) in various functions such as fuel-based power generation, chemical/cement/mineral processing, incineration, etc. Current technology filters include filter cartridges, which have filtration media and associated structures provided as a unit and “bag” media which envelope cages.

Focusing upon bag-type media, the underlying cages are generally elongate and have a cylindrical shape. The filtration bag generally has a shape that corresponds to the shape of the cage enveloped by the filtration bag. It is to be appreciated that placement of the filter media onto a cage involves an insertion movement of the cage into the bag, with the bag being a receptacle for the cage. The dimensions of the cage relative to the bag are such that the cage can be inserted into the filtration bag without binding of the bag and also such that the filtration bag is not damaged (e.g., torn, punctured, or otherwise stressed). As such, there is some amount of space or looseness of the filtration bag relative to the cage. In other words, the filtration bag is not form-fitting to the cage to allow the insertion to occur.

In view of the looseness of the bag, it is possible that some bag movement relative to the cage can occur during operation. For example, during filtration flow, the filtration bag may be forced against the cage because of a flow. However, during a pulse cleaning cycle, the filtration bag may move away from the cage. Movement of the filtration bag may cause stresses, wear or the like. It may be beneficial to reduce or eliminate some filtration bag movement to help avoid stress, wear, etc.

Such stress, wear, etc. can be more of an issue for certain types of bags. For example, some types of bags include glass fibers. One specific example type of glass-containing bags are bags that include woven glass fibers. Often the woven glass fibers may include fibers extending vertically and fibers extending horizontally. The glass fibers can and do break if bent/flexed beyond a tolerance level during bag movement. The above-mentioned relative bag movement can thus cause breakage of the glass fibers and/or wear due to abrasion of the bag adjacent the cage. Such fiber breakage may be especially prevalent at folds, pleats, creases or the like. Fibers that extend transversely to such folds, pleats, creases or the like may have a heightened amount of bending/flexing at the folds, pleats, creases or the like and thus may have a heightened propensity to break. As such, the bag may develop damage or wear “patterns” at the folds, pleats, creases or the like. For very long bags, the folds, pleats, creases tend to extend along the elongation of the bag. So, if the bag is vertically oriented, the folds, pleats, creases or the like would similarly be vertically extending. So, the damage or wear “patterns” may extend along the relatively long extent of the bag and thus can become significant.

Accordingly, it may be beneficial to reduce or eliminate relative movement of the bag and cage to help avoid stress, wear, etc.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a filter for use within a baghouse for filtering particulate material from fluid flowing through the filter. The filter is to be supported by a tubesheet of the baghouse. The filter includes an elongate bag that has an open end adapted to be disposed adjacent to the tubesheet and an encircling sidewall that extends from the open end to a distal end of the bag. The sidewall permits passage of fluid there through so that the fluid may pass through the bag and blocks passage of particulate material. The filter includes an elongate cage that is located within and supporting the bag and that has a variable effective length. The filter includes cage-associated structure for increasing the effective length of the cage to maintain the sidewall to be taut adjacent the cage.

In accordance with another aspect, the present invention provides a filter for use within a baghouse for filtering particulate material from fluid flowing through the filter. The filter is to be supported by a tubesheet of the baghouse. The filter includes an elongate bag that has an open end adapted to be disposed adjacent to the tubesheet and an encircling sidewall that extends from the open end to a distal end of the bag. The sidewall permits passage of fluid there through so that the fluid may pass through the bag and blocks passage of particulate material. The filter includes an elongate cage that is located within and supporting the bag and that has a variable effective length. The cage includes structure that inhibits movement of the cage relative to the tubesheet. The filter includes cage-associated structure for increasing the effective length of the cage to maintain the sidewall to be taut adjacent the cage.

In accordance with yet another aspect, the present invention provides a baghouse assembly that includes a housing. The housing includes a dirty fluid chamber and a clean fluid chamber separated by a tubesheet. The tubesheet has at least one aperture there through. The baghouse assembly includes a filter for filtering particulate material from fluid flowing through the filter. The filter to be supported by the tubesheet. The filter includes an elongate bag having an open end adapted to be disposed adjacent to the tubesheet and an encircling sidewall extending from the open end to a distal end of the bag. The sidewall permits passage of fluid there through so that the fluid may pass through the bag and blocking passage of particulate material. The filter includes an elongate cage located within and supporting the bag and having a variable effective length. The filter includes cage-associated structure for increasing the effective length of the cage to maintain the sidewall to be taut adjacent the cage.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a schematic illustration of an example baghouse having a plurality of bag type filters incorporating at least one aspect of the present invention;

FIG. 2 is a schematic representation of a portion of a bag-type filter of the example baghouse of FIG. 1 illustrating at least one possible aspect of the present invention of elongating an effective length of a cage to maintain a sidewall of a filter bag to be taut adjacent the cage;

FIG. 3 illustrates a specific example structure in accordance with the aspect shown within FIG. 2;

FIG. 4 illustrates another specific example structure in accordance with the aspect shown within FIG. 2;

FIG. 5 illustrates yet another specific example structure in accordance with the aspect shown within FIG. 2;

FIG. 6 is a schematic representation of a portion of a bag filter of the example baghouse of FIG. 1 illustrating at least another possible aspect of the present invention;

FIG. 7 is a schematic illustration of a portion of the bag-type filter with the cage located on a portion of a tubesheet of the example baghouse and illustrating another aspect of the present invention that inhibits movement of the cage relative to the tube sheet;

FIG. 8 is a pictorial illustration of a specific example filter located on the tube sheet as viewed from above into the filter, with the filter cage including the aspects of a two-part movable cage and a cage portion that inhibits movement of the cage relative to the tube sheet;

FIG. 9 is a perspective, partially torn-away illustration of the example filter of FIG. 8 on the tube sheet; and

FIG. 10 is a section view taken along line 10-10 in FIG. 8.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

FIG. 1 schematically shows an example of a baghouse 10 as an environment within which the present invention may be utilized. The baghouse 10 may be defined by an enclosed housing 12 and can be divided into two sections, a dirty fluid plenum 14 and a clean fluid plenum 16. The dirty fluid plenum 14 and the clean fluid plenum 16 are examples of dirty and clean fluid chambers, respectively. The dirty fluid plenum 14 and the clean fluid plenum 16 may be placed in fluid communication with each other and separated by a tubesheet 18, which is a wall, a divider, or the like. The dirty fluid plenum 14 is in fluid communication with a dirty fluid inlet port 20 allowing unfiltered fluid 22 (e.g., air, schematically represented by flow arrowhead) to enter the baghouse 10. The clean fluid plenum 16 is in fluid communication with a clean fluid outlet port 28 allowing filtered fluid 30 (e.g., air, schematically represented by flow arrowhead) to exit the baghouse 10. The dirty fluid plenum 14 and the clean fluid plenum 16 may be arranged in fluid communication via one or more circular apertures 32 formed in the tubesheet 18. Each aperture 32 may be sized to accept/hold or otherwise is associated with a filter 34 (shown in phantom within FIG. 1 to indicate that the filters are within the housing 12). Other than passage of fluid flow through the apertures 32, the tubesheet 18 prevents the passage of fluid. As such, fluid may pass from the dirty fluid plenum 14 to the clean fluid plenum 16 via the filters 34 and the associated apertures 32. It is to be appreciated that the baghouse 10 may be varied and the presented example is not to be taken as a limitation upon the present invention.

In the shown example of FIG. 1, five filters 34 are shown. However, the baghouse may include any number (i.e., one or more) of filters 34. The filters 34 are generally elongate may be arranged parallel (e.g., axes of elongation are parallel) to each other in a substantially vertical manner. It is to be appreciated that the filters are only schematically shown in FIG. 1 and that the Figure and the contents thereof are sized for easy of illustration. Actually, embodiments may have various filter lengths (e.g., 12-20 ft., and typically 16-18 ft.)

The filters 34 are capable of filtering fluid (e.g., air) to remove a variety of particles carried in fluid flowing through the filters. For example, the filters 34 may be used, but are not so limited, to filter hot gas(es) resulting from fuel combustion associated with electrical energy generation. In other examples, the filters 34 may be used in other applications such as chemical/cement/mineral processing, incineration, etc.

The schematically shown filters 34 may have varied structures/configurations. However, the filters have the following aspects. For each filter 34, the filter includes an elongate cage 42 and an elongate filtration bag 44. For the discussion herein, a single filter 34 is discussed with the understanding that the discussion may be equally applicable to the other filters.

The cage 42 is supported by the tubesheet 18. In the shown example, the cage 42 hangs from the tubesheet 18 into the dirty fluid plenum 14. The cage 42 may be made of a number of different materials such as metal (e.g., steel, stainless steel, or the like), and may be sufficiently stiff to provide support to the elongate filtration bag 44. The cage 42 has a general elongate cylindrical shape. The elongation is along a central axis 48. The cage 42 is hollow and thus bounds an interior volume 52 of the filters 34, which is open to the clean fluid plenum 16 via the associated apertures 32 in the tubesheet 18. As such, the interior volume 52 defines an elongated central passageway within the filter 34 to the clean fluid plenum 16. The cage 42 includes openings on its surface to allow for the passage of fluid through the cage into the interior volume 52. For instance, the cage 42 may include a plurality of spaces, perforations, apertures, holes, mesh, etc. to allow fluid passage. In one example type, the cage 42 is constructed to include a plurality of spaced and intersecting metal wires welded together. As such, the area between adjacent wires provide the spaces, etc. through which flow occurs.

The filtration bag 44 is made of material to provide a desired filtering function and capture/block progress of particulate that is proceeding with the unfiltered fluid 22 entering the dirty fluid plenum 14. It is to be appreciated that the material of the filtration bag 44 may be varied and may be chosen based upon the specific of the particulate that is being filtered from the fluid. As such, specifics of the material for the filtration bag 44 need not be specific limitations upon the present invention. Although the specifics of the bag material need not be a limitation, it should be noted that the present invention has particular usefulness for bags than include woven glass laminated to an expanded polytetrafluoroethylene (ePTFE) membrane.

The filtration bag 44 is arranged as a bag shape or tube to envelope the cage 42. The filtration bag 44 has an opening (i.e., an open end) at an upper end that surrounds the cage 42 adjacent to the location of the cage engagement/connection to the plenum sheet. Although it is not shown with the schematic drawing of FIG. 1, the filtration bag 44 is secured to the cage/plenum sheet adjacent to the open end of the filtration bag (i.e., adjacent to the cage/plenum engagement/connection). The securing may be via a retaining bracket or the like. The filtration bag 44 has an encircling sidewall 54 extending from the open end to a closed, distal end 56 along a direction of the axis 48 of the filtration bag 44. The bag sidewall 54 permits passage of fluid there through so that the fluid may pass from the dirty fluid plenum 14 to the clean fluid plenum 16 while blocking passage of at least some particulate material against proceeding to the clean fluid plenum. The cage 42 retains the encircling sidewall 54 of the filtration bag 44 spaced from the central axis 48.

It is to be appreciated that the filtration bag 44 may be removed from the cage 42. Such, removal may permit replacement or other functions (e.g., maintenance). Installation of the filtration bag 44 onto the cage 42 entails relatively inserting the cage into the open end of the filtration bag, and pulling the bag up (as viewed in the Figures) relative to the cage. It is to be appreciated that at least some amount of slack or looseness exists between the filtration bag 44 and the cage 42. Another way of saying this is that the filtration bag 44 does not form-fit or press-fit against the cage 42 during the installation of the filtration bag unto the cage. Such looseness can help to provide ease of bag installation (e.g., the filtration bag does not bind during installation). In addition, such looseness can help avoid snagging, tearing, puncturing, or otherwise stressing of the filtration bag 44 during installation.

Although looseness of the filtration bag 44 may have some benefits, especially during installation, filtration bag looseness may have some detriments. For example, bag looseness may allow movement of the filtration bag 44 during operation of the baghouse 10. As one specific example, it is to be expected that during flow for filtration, the filtration bag 44 will be pressed against the cage 42. This is due to the flow and the pressure differential between the outside and inside of the filtration bag 44. However, during a reverse-flow pulse for the purpose of cleaning (i.e., dislodging accumulated particulate), the filtration bag 44 may move away from the cage 42. In addition, it is even possible that looseness of a filtration bag 44 could allow the filtration bag 44 to move (e.g., vibrate or ripple) during the filtering process.

Possibly dependent upon the amount of movement, the movement may be associated with the introduction of stresses, wear or the like to the filtration bag 44. It may be beneficial to reduce or eliminate some filtration bag movement to help avoid stress, wear, etc. In the past, efforts to eliminate bag looseness and thus efforts to reduce stresses, wear or the like included an approach of manufacturing/configuring the filtration bag to have a reduced cross-sectional diameter of the bag based upon the diameter of the associated cage. In other words, the prior approach was to make/configure the bag diameter only large enough to fit over the outer diameter of the cage. It is to be appreciated that the manufacturing/configuring the filtration bag to have a relatively reduced cross-sectional diameter is a pre-installation approach. However, pre-installation bag diameter relative reduction was coupled to increases in bag installation difficulty, propensity for bag damage during installation, and the like. In accordance with an aspect of the present invention, at least some filtration bag movement is reduced or eliminated by reducing or eliminating looseness (e.g., slack) in the filtration bag 44 subsequent to installation of the filtration bag onto the cage 42.

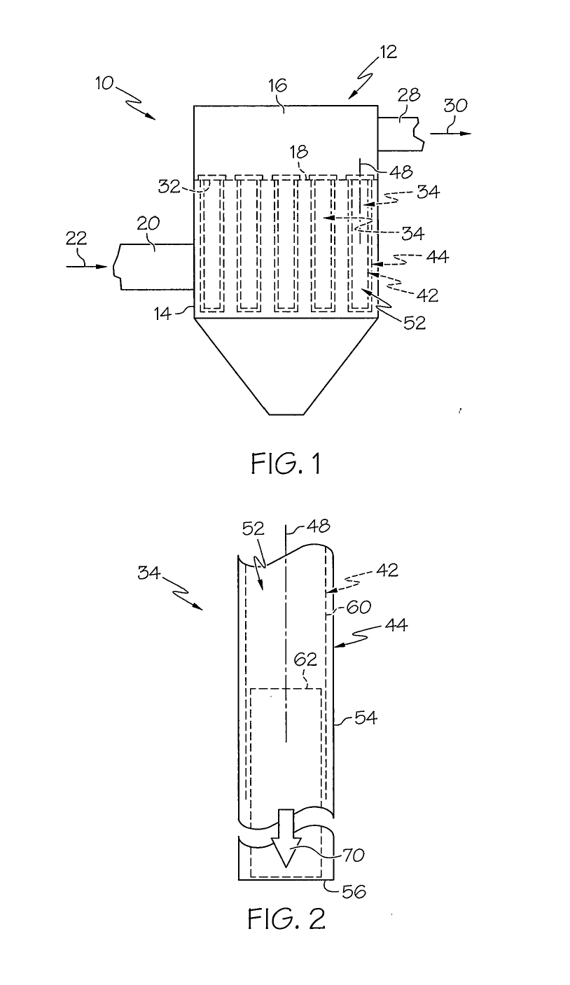

In accordance with an aspect of the present invention, FIG. 2 shows an example of a construction of the filter 34 (only partially shown) to help reduce or eliminate slack in the filtration bag 44. With the shown example, the cage 42 of the filter 34 is provided as a multi-part (e.g., two-part) construction. Specifically, within the shown example, the cage 42 has an upper part 60 and a lower part 62, with the lower part being able to axially telescope relative to the upper part. It is to be appreciated that within FIG. 2 and subsequent Figures, the cage 42 is shown in phantom because the cage is hidden within the filtration bag 44. In addition, it is to be appreciated that the upper and lower cage parts 60 and 62 of the cage are only schematically shown. As such, specific details can certainly be varied. In the shown example, the lower cage part 62 has an outer diameter that is smaller than an inner diameter of the upper part 60. Of course, the construction can be different. Relative movement of the upper and lower cage parts 60, 62 will vary the effective axial length (e.g., elongation dimension) of the cage 42. Elongation of the cage 42 will reduce or even eliminate looseness or slackness in the filtration bag 44.

It is to be appreciated that an variation of length or elongation (e.g., relative movement of the upper and lower cage parts 60, 62) of the cage 42, alone, may not be a complete solution. It is to be appreciated that the operation of the baghouse 10 (e.g., the filtering function and/or the reverse flow cleaning operation) may and typically does cause force(s) to be applied to the filtration bag 44 and such force(s) can be transferred from the filtration bag to the cage 42. As such, in accordance with an aspect of the present invention, the cage 42 is configured to provide a force or be otherwise have biasing that causes the cage to urge toward elongation and thus retain the accomplished elongation. See FIG. 2, which shows a generic downward force 70 indicated by an arrowhead. Such force/bias can act in opposition to force(s) transferred from the filtration bag 44 to the cage 42 that would otherwise urge the cage to a shortened length. The provision of a force or otherwise to have bias that causes the cage to urge toward elongation is via means, associated with the cage, for forcing the filtration bag sidewall 54 to be taut along a direction parallel to the central axis 48 and thus taut against the sides of the cage 42. In other words, there is some cage-associated structure for increasing/elongating the effective length of the cage to maintain the bag sidewall 54 to be taut adjacent to the cage 42.

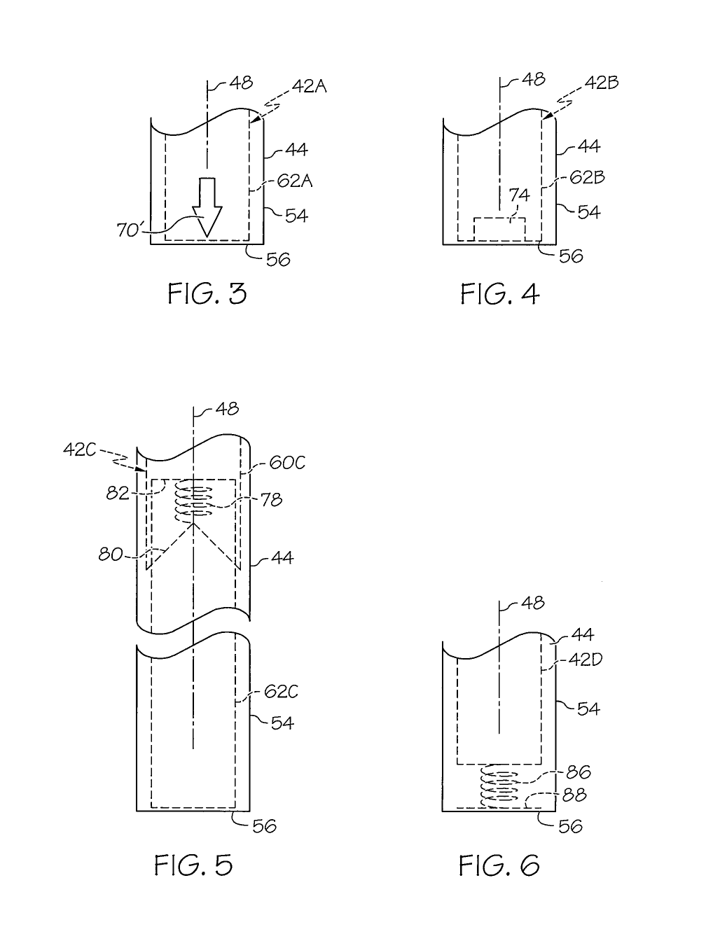

In one specific example (see FIG. 3, only a portion of the lower cage part 62A and a portion of the elongate filtration bag 44 are shown), the cage 42A is configured to provide the force/bias urging toward elongation is via weight of the lower cage part 62A. Within this example, an alphabetic suffix “A” is added to the reference numerals for the cage and the lower cage part to indicate that the cage/lower cage part may have some specific variation within this example. Of course, the upper and lower cage parts are relatively moveable along the axis and such relative movement of the upper and lower cage parts will vary the effective axial length (e.g., elongation dimension) of the cage.

The weight of the lower cage part 62A operates in conjunction with the lower cage part being relatively free to move with respect to the upper cage part (not shown in FIG. 3). Specifically, note that within the present examples (See FIG. 1), the cage 42 is supported (e.g., hung) below the tubesheet 18 and also that the lower cage part 62A can move, axially downward relative to the upper cage part supported by the tubesheet 18. As such, gravity is a force acting to pull the lower cage part 62A downward and increasing/elongating the overall axial cage length (i.e., axial dimension). FIG. 3 which shown a downward force indicated by an arrowhead 70′, which represents the weight of the lower cage part 62A. Weight of the lower cage part 62A thus factors into the amount of force, via gravity, that is urging the lower cage part to move downward. Elongation of the overall axial cage length (i.e., length increase) occurs when the lower cage part 62A moves down. Filtration bag looseness or slackness is reduced or removed via the cage elongation. As such, construction of the lower cage part 62A can be configured to have sufficient weight to provide a desired force via gravitational force. Some specific examples of such lower cage part construction configuration may include use of materials of heavier density and/or increased size (e.g., thickness) to provide increased mass as compared to conventional cage construction configurations. The lower cage part 62A provides one example means, which is cage-associated structure, for elongating the effective length of the cage 42A that forces the bag sidewall 54 to be taut along a direction parallel to the central axis 48 and maintains the sidewall to be taut adjacent the cage.

In another specific example (see FIG. 4, only a portion of the lower cage part 62B and a portion of the elongate filtration bag 44 are shown), the cage 42B is configured to provide the force/bias urging toward elongation is via addition of a mass or weight 74 (schematically illustrated) to the lower cage part 62B. Within this example, an alphabetic suffix “B” is added to the reference numerals for the cage and the lower cage part to indicate that the cage/lower cage part may have some specific variation within this example. FIG. 4 generically shows the added weight 74 at the bottom of the lower cage part 62B, but the weight may be otherwise located within the lower cage part. It is to be appreciated that the added weight 74 is considered to be an addition to the lower cage part 62B since the added weight does not otherwise provide any feature/function/etc. of the cage. As such, the weight 74 is solely provided for the function of increased weight force. This is in distinction to the example discussed immediately above since the weight increase was within the cage structure itself. Since the added weight 74 is sole for weight purposed, very dense materials can be used regardless of ability to otherwise be used with cage construction since there is no need for the added weight to provide other cage-construction functions.

Of course, the upper and lower cage parts are relatively moveable along the axis and such relative movement of the upper and lower cage parts will vary the effective axial length (e.g., elongation dimension) of the cage. As can be appreciated, the added weight 74, possible in conjunction with the weight of the remainder of the lower cage part 62B, provides a downward force and urges elongation (i.e., increase) of the overall cage axial length (i.e., axial dimension). Bag looseness or slackness is reduced or removed via the cage elongation. The added weight 74, possible in conjunction with the weight of the remainder of the lower cage part 62B, provides one example means, which is cage-associated structure, for elongating the effective length of the cage 42B that forces the bag sidewall 54 to be taut along a direction parallel to the central axis 48 and maintains the sidewall to be taut adjacent the cage.

In another specific example (see FIG. 5 in which portions of the upper and lower cage parts 60C, 62C and the elongate filtration bag 44 are illustrated as being torn-off simply to permit better viewing), a biasing spring (schematically shown) 78 is included in the cage 42C to bias the relatively movable upper and lower cage parts 60C, 62C in opposite directions so as to urge elongation (i.e., increase) of the over length of the cage. Within this example, an alphabetic suffix “C” is added to the reference numerals for the cage and the cage parts to indicate that the cage/parts may have some specific variation within this example. Of course, the upper and lower cage parts 60C, 62C are relatively moveable along the axis 48 and such relative movement of the upper and lower cage parts will vary the effective axial length (e.g., elongation dimension) of the cage 42C.

The inclusion and configuration of a bias spring 78 to urge overall cage elongation can be varied and such variations are within the scope of the present invention. Within the shown example of FIG. 5, the bias spring 78 is an extension spring (i.e., the spring has a bias to decrease in length). The upper cage part 60C has an interior spring engagement portion 80 (schematically shown) adjacent to a bottom of the upper cage part. The lower cage part 62C has an interior spring engagement portion 82 (schematically shown) that is adjacent to an upper end of the lower cage part. The spring engagement portion 80 of the upper cage part 60C is axially below the spring engagement portion 82 of the lower cage part 62C with the bias spring 78 extending along the axis 48. Thus, the bias spring 78 is interposed between the upper and lower cage parts 60C, 62C. In view of the bias provided by the spring 78, the spring engagement portion 82 of the lower cage part 62C is pulled relatively downward as viewed within FIG. 5. As such, the lower cage part 62C is urged downward and thus the bias spring 78 urges elongate of the overall cage axial length (i.e., axial dimension). Bag looseness or slackness is reduced or removed via the cage elongation. As mentioned, other configurations that include a bias spring are contemplated. For example, a compression spring (i.e., the spring has a bias to increase in length) could be used and be positioned between portions of the upper and lower cage parts to again urge overall cage elongation. The bias spring 78 is at least part of another example means, which is cage-associated structure, for elongating/increasing the effective length of the cage 42C that forces the bag sidewall 54 to be taut along a direction parallel to the central axis 48 and maintains the bag sidewall to be taut adjacent the cage.

With regard to use of a compression spring (i.e., the spring has a bias to increase in length), it is further contemplated that a compression spring 86 could be used with a cage 42D that may or may not have relatively moveable cage upper and lower parts for the purpose of reducing or removing bag looseness or slackness. FIG. 6 schematically shows an example of such a configuration. Within this example, an alphabetic suffix “D” is added to the reference numeral for the cage to indicate that the cage may have some specific variation within this example.

Within the specific example of FIG. 6, the compression spring 86 (schematically shown) is located axially below a bottom of the cage 42D within the elongate filtration bag 44. In other words, the spring 86 is adjacent to a bottom end of the cage 42D. As such, the spring 86 is located between the cage 42D and the bag 44 at its distal end 56. A plate or other member 88 (schematically) is located axially bellow the spring 86 (i.e., between the spring and the bag). In other words, the spring 86 is between the cage 42D and the plate 88, with the cage 42 D and the plate 88 being at opposed ends of the spring 86. As such, the plate 88 is urged downward away from the bottom of the cage 42D. Thus, the overall distance (i.e., axial dimension) from a top of the cage 42D (i.e., adjacent to the tubesheet 18, not shown in FIG. 6, refer to FIG. 1) to the plate 88 is increased or elongated via the spring bias. The cage 42D and the plate 88 cooperate to provide an overall effective axial cage length, and such relative movement will vary the effective axial cage length (e.g., elongation dimension). Bag looseness or slackness is reduced or removed via the elongation of the overall distance. The spring 86 is at least part of another example means, which is cage-associated structure for elongating/increasing the effective length of the cage 42D, that forces the bag sidewall 54 to be taut along a direction parallel to the central axis 48 and maintains the sidewall to be taut adjacent the cage.

It is to be appreciated that variations of the cage-associated structure for forcing the bag sidewall 54 to be taut along a direction parallel to the central axis 48 and taut adjacent to the cage are contemplated and are to be considered to be within the general scope of the invention. For example, various combinations of the above-discussed means for forcing the bag sidewall 54 to be taut are possible. Some specific examples of the combinations include: use of a spring and the weight of the lower cage part example, and use of an additional weight and a spring. Still further, it is contemplated that variations of the above-discussed means for forcing the bag sidewall 54 to be taut may include various permutations. Some specific examples include use of multiple additional weights and use of multiple biasing springs.

Now it is contemplated that accomplishment of the desired tautness of the bag sidewall 54 may allow some increased propensity for the filter 34 (see FIG. 1) to be moved. Specifically, there may be an increased propensity for the filter 34 to be moved upwardly, relative to the tubesheet 18 through the respective aperture 32 of the tubesheet 18. Such upward movement could cause the filter 34 to be at least partially upwardly backed-out (e.g., partially ejected or displaced) from the tube sheet 18. It is to be appreciated that upward ejection/displacement may result is at least some unfiltered fluid (e.g., air) being able to pass the tube sheet 18 and enter the clean air plenum 16. As can be appreciated, passage of unfiltered fluid to the clean air plenum 16 is not desirable.

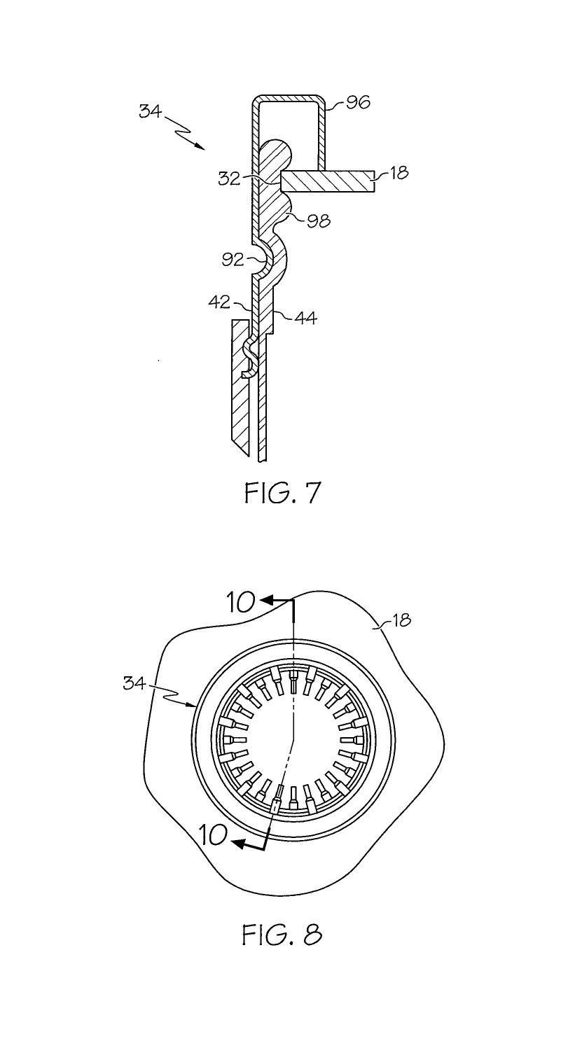

As such, in accordance with another aspect of the present invention, the cage 42 (see FIG. 7) can be provided with structure 92 that inhibits movement of the cage 42 relative to the tube sheet 18. It is to be appreciated that the structure for inhibiting movement of the cage 42 relative to the tube sheet 18 can be utilized/present in any of the several presented examples (e.g., see the examples FIGS. 2-6) of the cages with the cage-associated structure for elongating the effective length of the cage to maintain the sidewall to be taut adjacent the cage. Still further, it is to be appreciated that the structure 92 for inhibiting movement of the cage 42 relative to the tube sheet 18 can be utilized/present in other examples cages with the cage-associated structure for elongating the effective length of the cage to maintain the sidewall to be taut adjacent the cage. As such, one example of the structure for inhibiting movement of the cage 42 relative to the tube sheet 18 is generically presented within FIG. 7 with the understanding that generic presentation can be applied to various specific examples.

As can be appreciated, FIG. 7 is an enlarged, partial view of a top of the filter 34 adjacent to the tubesheet 18. The top of the filter 34 is provided as a portion 96 of the cage that extends through the aperture 32 and is configured to be a lip. The lip 96 has a diameter that is greater than a diameter of the aperture 32 and is positioned above the tubesheet 18. As such the lip 96 cannot pass downwardly through the aperture 32. It is to be appreciated that the bulk of the filter 34 extends (e.g., hangs) below the tubesheet 18 and the filter 34 is supported upon the tubesheet 18 via the lip 96 located above the tubesheet 18. The elongate filtration bag 44 has a portion 98, commonly referred to as a snap-band, that at least partially extends with the cage 42 through the aperture 32 of the tubesheet 18. The snap-band portion 98 of the elongate bag 44 is not a portion that is for fluid filtration but instead is for bag retention. As such, the snap-band 98 can be made of a different material than the portion for filtration and does not permit fluid flow therethough. As can be seen in FIG. 7 the snap-band portion 98 can be form-fitting into the aperture 32 to seal against fluid flow there-past and also to engage and press against the tubesheet 18 at the aperture. More specifically, it can be appreciated that some bulging of the bulk of the snap band 98 may occur above and below the tubesheet 18 at the aperture 32.

Turning to the structure 92 that inhibits movement of the cage 42 relative to the tube sheet 18, it is to be appreciated that the shown example is an outwardly extending bulge or bump 92 on the filter cage 42 just below the tube sheet 18. The bump 92 thus has a greater diameter than the adjacent segment of the cage 42. It is to be appreciated that the bump 92 may be provided as a continuous, annular ring, or and one or increased diameter segments (e.g., dots) located about the periphery of the portion of the cage 42 below and adjacent to the tubesheet 18. Of course, the example of the bump 92, either continuous or segmented, as the structure that inhibits movement of the cage 42 relative to the tube sheet 18 is but one example and should not be considered to be the only possible example and is thus not a specific limitation upon the invention.

Turning to the operation of the structure (e.g., the bump) 92 that inhibits movement of the cage 42 relative to the tube sheet 18. If there is propensity of the filter 34 to be moved upwardly relative to the tubesheet 18 (e.g., possibly in connection with the inventive aspect of elongating the effective length of the cage to maintain the sidewall to be taut adjacent the cage as shown in FIGS. 2-6), there is a risk that the filter 34 will be partially expelled/ejected upwardly (e.g., backed-out) from the tubesheet 18, the sealing effect could be lost, unfiltered fluid (e.g., air) could be permitted to pass, and the like. However, due to the presence of the bump 92, the bump with push upon the snap-band portion 98 of the filter bag 44 and cause further bulging/collecting of the snap-band material below the tubesheet 18. Thus, an increased amount of block or binding force is created that prevents the upward movement of the filter 34 relative to the tubesheet 18.

A specific example of a two-part, elongation cage 34 that includes the structure 92 for inhibiting movement of the cage 42 relative to the tube sheet 18 is pictorially shown in FIGS. 8-10. The specific example can be of the types of cage configurations that are shown with the schematic representations shown in FIGS. 2-4. As such, FIGS. 8-10 provides a specific example of both the cage-associated structure for elongating the effective length of the cage to maintain the sidewall to be taut adjacent the cage and the structure that inhibits movement of the cage relative to the tube sheet.

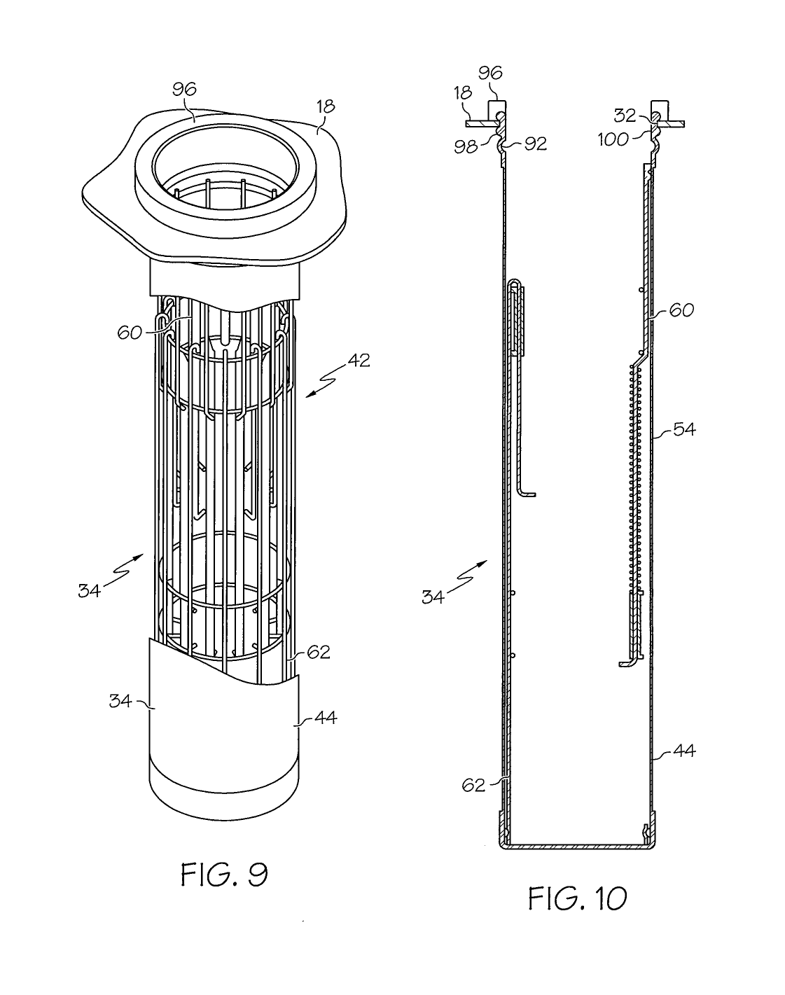

It should be appreciated that within the example of FIGS. 8-10, the maximum diameter of the bump 92 need not be greater than the diameter of the aperture 32 in the tubesheet 18. So long as the bump 92 is capable of causing the desired bulging of the snap-band portion 98 below the tubesheet 18, the bump 92 need not be so large as to itself dimensionally interfere with the tubesheet 18 at the aperture 32. This allows ease of initial insertion (i.e., downwardly as viewed in FIGS. 8 and 9) through the tube sheet 18.

As best seen in FIGS. 9 and 10 the two-part cage is mostly constructed of wire-form. For each cage part, the wires are welded or otherwise adhered together. Although the upper and lower cage parts 60 and 62 are not welded to each other, some wires may interloop to provide a sliding guidance between the two parts. As such, the lower cage part 62 can move relative to the upper cage part 60. As such the overall length of the cage 42 can be increased so as to maintain the bag sidewall 54 to be taut adjacent the cage 42.

In the example, an upper segment 100 of the upper cage part 60 is not made of wire-form but instead is an annular metal band. The band can be formed from an initially flat metal piece that is rolled into a hoop. The wire portion of the upper cage part 60 can be welded or otherwise adhered to the metal band. Turning to the example bump 92, the bump is an annular ring-like out-dent formed in the metal band. As such, the out-dent bump 92 is outwardly extending. At the out-dent bump 92 at the metal band the overall cross-section of the cage is enlarged. As will be recalled, the aperture 32 of the tubesheet 18 has a cross-sectional area. Also recall that the snap-band 98 extends through the aperture 32 and thus the snap-band 98 extends on/over the bump 92. Still further, recall that there is at least some bulging of the snap-band 98 at the location of the aperture 32. The bulged portion of the bag snap-band 98 in combination with the cage bump 92 provide for an overall cross-sectional area footprint greater than the cross-sectional area of the aperture 32 of the tubesheet 18. Thus, upward movement of the filter 34 is inhibited.

The invention has been described with reference to the example embodiments described above. Modifications and alterations will occur to others upon a reading and understanding of this specification. Examples of embodiments incorporating one or more aspects of the invention are intended to include all such modifications and alterations insofar as they come within the scope of the appended claims.

What is claimed is:

1. A filter for use within a baghouse for filtering particulate material from fluid flowing through the filter, the filter to be supported by a tubesheet of the baghouse, the filter including:
an elongate bag having an open end adapted to be disposed adjacent to the tubesheet and an encircling sidewall extending from the open end to a distal end of the bag, the sidewall permitting passage of fluid there through so that the fluid may pass through the bag and blocking passage of particulate material;
an elongate cage located within and supporting the bag and having a variable effective length; and
cage-associated structure for increasing the effective length of the cage to maintain the sidewall to be taut adjacent the cage.

2. A filter as set forth in claim 1, wherein the cage includes structure that inhibits movement of the cage relative to the tubesheet.

3. A filter as set forth in claim 2, wherein the tubesheet extends horizontally and the filter extends vertically downward from the tubesheet, the structure that inhibits movement of the cage relative to the tubesheet inhibits upward movement of the cage relative to the tubesheet.

4. A filter as set forth in claim 2, wherein the cage has a circular cross-section and the structure that inhibits movement includes a portion having an enlarged cross-section.

5. A filter as set forth in claim 4, wherein the portion having an enlarged cross-section is a portion that has an outwardly extending bump.

6. A filter as set forth in claim 5, wherein the aperture of the tubesheet has a cross-sectional area, a portion of the bag at the open end of the bag extends over the bump and through the aperture, and the bump and the portion of the bag extending over the bump have an overall cross-sectional area greater than the cross-sectional area of the aperture of the tubesheet.

7. A filter as set forth in claim 1, wherein the cage-associated structure for increasing the effective length of the cage includes at least one of a spring, a weight and a plate.

8. A filter as set forth in claim 7, wherein the spring is a compression spring.

9. A filter as set forth in claim 8, wherein the compression spring is located between the cage and the bag at the distal end.

10. A filter as set forth in claim 7, wherein the spring is an extension spring.

11. A filter as set forth in claim 10, wherein the cage includes two relatively movable parts and the extension spring biases the parts of the cage to increase a dimension of the cage along the central axis.

12. A filter as set forth in claim 11, wherein the extension spring is interposed between the parts of the cage.

13. A filter as set forth in claim 7, wherein the cage includes two relatively movable parts and the spring biases the parts of the cage to increase a dimension of the cage along the central axis.

14. A filter as set forth in claim 1, wherein the cage includes two relatively movable portions.

15. A filter as set forth in claim 14, wherein the cage-associated structure for increasing the effective length of the cage includes weight of one of the relatively movable portions.

16. A filter as set forth in claim 14, wherein the cage-associated structure for increasing the effective length of the cage includes an added weight within one of the relatively movable portions.

17. A filter for use within a baghouse for filtering particulate material from fluid flowing through the filter, the filter to be supported by a tubesheet of the baghouse, the filter including:
an elongate bag having an open end adapted to be disposed adjacent to the tubesheet and an encircling sidewall extending from the open end to a distal end of the bag, the sidewall permitting passage of fluid there through so that the fluid may pass through the bag and blocking passage of particulate material;
an elongate cage located within and supporting the bag and having a variable effective length, the cage including structure inhibiting movement of the cage relative to the tubesheet; and
cage-associated structure for increasing the effective length of the cage to maintain the sidewall to be taut adjacent the cage.

18. A baghouse assembly including:
a housing including a dirty fluid chamber and a clean fluid chamber separated by a tubesheet, the tubesheet having at least one aperture there through; and
a filter for filtering particulate material from fluid flowing through the filter, the filter to be supported by the tubesheet, the filter including:
an elongate bag having an open end adapted to be disposed adjacent to the tubesheet and an encircling sidewall extending from the open end to a distal end of the bag, the sidewall permitting passage of fluid there through so that the fluid may pass through the bag and blocking passage of particulate material;
an elongate cage located within and supporting the bag and having a variable effective length; and
cage-associated structure for increasing the effective length of the cage to maintain the sidewall to be taut adjacent the cage.

19. A baghouse assembly as set forth in claim 18, wherein the cage includes structure that inhibits movement of the cage relative to the tubesheet.

20. A baghouse assembly as set forth in claim 18, wherein the cage-associated structure for increasing the effective length of the cage includes at least one of a spring, a weight and a plate.
